(19) United States
(12) Patent Application Publication
(10) Pub. No.: US 2011/0193959 A1
(43) Pub. Date: Aug. 11, 2011

(54) Modular minihelicopter

(75) Inventor: Steven Roger Brandon, Tucson, AZ (US)

(73) Assignees: Mr. Lyle Marvin Tweet, Tucson, AZ (US); Mrs. Rosemary Buckingham Tweet, Tucson, AZ (US)

(21) Appl. No.: 12/658,543

(22) Filed: Feb. 11, 2010

(51) Int. Cl. H04N 7/18; B64C 27/82; B64D 7/00

(52) U.S. Cl. 348/144; 244/17.21; 89/37.16; 348/E07.091

(57) ABSTRACT

This device, a modular minihelicopter, is a radio-controlled, gas-powered aircraft designed to perform varying missions based upon the functions of interchangeable modular-systems mounted on the minihelicopter's chassis.

Modern military missions have a need to maximize infliction of damage upon the enemy while minimizing the risk of friendly casualties. “Smart” weapons achieve these goals, but oftentimes costs and delivery modalities are prohibitive. These systems rely upon satellites and this reliance can render them unavailable in situations where they are needed most.

This device, the modular minihelicopter encompasses an aerial platform and delivery system that is extremely mobile and flexible while providing a local user with local control of the delivery system through a remote control option instead of a satellite control.

This modular minihelicopter is a gas-powered, remote-controlled aircraft. The remote aircraft is hand-held and controlled by a local user within range of the radio control. This gives the minihelicopter controller an extremely flexible and accurate local control of the flight of the minihelicopter.

The modular minihelicopter contains a remote camera on the front to provide for surveillance and guidance during flight. This remote camera allows for the user to operate the minihelicopter from a safe, covered location. The minihelicopter can be flown into harms's way while the user remains safe.

The modular minihelicopter will carry multiple onboard modular interchangeable weapons on reconnaissance systems. These systems will fit into a modular housing on the frame of the chassis of the minihelicopter. These systems include: 1. Lights. 2. Flares/Grenades. 3. Cameras. 4. Smoke.

The modular minihelicopter will also feature a second interchangeable modular system. Both interchangeable modular systems will significantly aid in break-down and set up time, ease of use and operation, functionality, and cost control.

The second interchangeable modular system will be with the camera guidance system onboard the aircraft. Alternative cameras will be able to be easily interchanged depending on the needs of the user. These cameras will include traditional video cameras, infrared cameras, lasers, and x-rays cameras.

The combination of these functions and systems will allow the user to conduct extremely localized missions with a minimum of risk to allies and innocents while providing effective and specifically targeted enemy suppression.

I claim:

1. A device, a “minihelicopter,” a helicopter of small to medium size, consisting of a gas-powered engine driving two rotors, the main rotor being horizontal and driven by a shaft running vertically through the center of mass of said minihelicopter and the secondary rotor being vertically-oriented at the end of the tail of said minihelicopter. The gas engine is positioned around the position of the main rotor shaft to provide the aircraft with a proper center of mass. Said minihelicopter will be remote controlled through conventional remote control methods. Said minihelicopter will be able to be controlled guided through an onboard camera in the nose of the aircraft and by a video monitor in possession of the user with the remote control.

2. A wireless remote-controlled camera guidance system in the nose of said minihelicopter of claim 1. The camera system will provide direct onboard visual guidance for a user to fly the minihelicopter of claim 1 even if the user is unable to directly view the flight path of minihelicopter firsthand.

3. The wireless remote-controlled camera system of claim 2 will consist of a wireless remote camera of sufficient pixel density and shutter speed such that the remote user can fly the minihelicopter of claim 1 to its physical aerial limitations via remote control through the onboard camera without ever having to directly observe the chassis of said minihelicopter of claim 1 while the aircraft is in flight. The aforementioned onboard video camera unit will provide the main method of directing the flight of the minihelicopter by transmitting live video images to the video receiver monitor unit but the radio remote control unit shall also provide the user will the ability to direct the flight of the aircraft through visual observation and manual manipulation of the remote control unit.

4. The video and radio remote control unit of claim 3 for the aforesaid minihelicopter of claim 1 shall contain antennae of sufficient length and power such that the user may remotely control the aircraft without the necessity of maintaining a direct line of sight between user and aircraft.

5. The wireless camera system of claim 2 shall include a receiver with a television-type video monitor which will receive and project pictures from the onboard camera to the user with the remote control. The wireless camera unit of claim 3 shall be affixed to the nose of said minihelicopter and the receiving video monitor shall be part of the remote control apparatus unit remaining in possession of the user with the remote control.

6. The wireless camera system of claim 2 that is affixed to the nose of said minihelicopter of claim 1 shall be remotely operable and moveable independently of the flight direction of the aircraft. The wireless camera system of claim 2 in the nose of said minihelicopter shall be able to be aimed, focused, zoomed, and perform all other conventional functions of a video camera. Additionally, said wireless remote camera shall have the interchangeable modular alternatives for infrared, laser, and x-ray camera capabilities. The interchangeable modularity of these alternative cameras means they will fit into the same mounting brackets on the chassis of the minihelicopter and they will fit into the same electronic and remote control wiring systems so that they can be removed and replaced with a minimum of time and reconfiguration. All the views from the alternative cameras could be remotely viewed by the user with the remote control through the images' radio transmission from said minihelicopter to the user's remote video monitor.

7. An interchangeable modular weapons system attached to the central frame of the minihelicopter of claim 1. The separate interchangeable weapons systems include flares, lights, grenades, and smoke grenades. The system is modular and interchangeable in function because the physical and electronic mountings on the said minihelicopter chassis of claim 1 accommodate each weapon system without the need for major reconfiguration. Likewise, the housings on the weapons systems are all standard and uniform, regardless of which weapons system they are. This allows the housings on the various weapons systems to fit into the mountings on the minihelicopter chassis so that the weapons can change but the minihelicopter need not. This multi-functionality and interchangeability in the weapons systems and camera systems in a small, gas-powered remote controlled helicopter is a new function and significant alteration, modification, and improvement claimed in this patent application.

8. The flares, lights, grenades, and smoke grenades all require separate and independent housings. These features will be contained in housings compatible with the mountings on the chassis of said minihelicopter of claim 1. The flares, lights, grenades, and smoke grenades of claim 7 are covered by other owners and other patents and are not claims here but mentioned solely for illustrative purposes to demonstrate the overall novelty and utility of the device at issue in the current patent application.

9. The interchangeable modular systems will provide for manual attachment, installation, and detachment of the modular camera and modular weapons systems. The systems will be designed to maintain the proper aerodynamics and balance of the entire minihelicopter of claim 1.

10. The interchangeable modular system for the weapons options shall be to slide the weapons housing into a mounting bracket. The weapons housing shall then be tightened into place via conventional nuts and bolts. The electronics for the weapons systems shall be plug-in-type with the female side being on the modular weapons housing and the male plug and wire being on the chassis of the minihelicopter of claim 1.

11. The interchangeable modular system for the camera options shall consist of the modular camera units sliding into a bracket and then using conventional nuts and bolts to secure them into position. The electronics connection for the camera options shall consist of internalized connections at the rear of the camera housings. The camera housings shall slide into place on their brackets in their housings on the chassis of the helicopter. At the rear of both the camera housing and the chassis mounting will be the optics power cords and electronics. These modular housings for the cameras shall consist of female couplings. The respective male couplings shall extend from the internalized position of the rear of the opening for the camera housing. The male couplings shall be varied in order to provide for the different electronic and optic needs of the cameras in the selected housing. In this manner, all varieties of cameras can be accommodated for physically and electronically.

12. All attachments and systems of the minihelicopter of claim 1 will be attached to the minihelicopter chassis to balance all loads and maintain proper flying dynamics.

13. Gas-powered remote-controlled helicopters have already been invented so their invention is not claimed as part of this patent application. The new and non-obvious essential claims of this patent are the use of gas-powered remote-controlled helicopters to be equipped with the newly combined functions listed herein and to be used for the newly described purposes listed herein. Any claim to a specific design of a remote-controlled, gas-powered helicopter is specifically disclaimed.

14. Other portions of this patent application are either within the public domain or not being claimed separately. This patent application for the modular minihelicopter should be considered in totality as many of the parts claimed are already in the public domain or are covered by various other derivations of patents which shall remain unnamed herein because only the totality of the modular minihelicopter device and function is being claimed by this patent application. All pre-existing patents covering parts used in the modular minihelicopter are specifically disclaimed as only the totality of the operational function and physical structure of the said minihelicopter are intended to be new and non-obvious, substantial improvements to existing devices, and otherwise covered under existing patent coverages. None of the claims is being made for the individual parts of the modular minihelicopter by themselves but rather as a whole.
